(19) United States
(12) Patent Application Publication
(10) Pub. No.: US 2016/0233523 A1
(43) Pub. Date: Aug. 11, 2016

(54) FUEL CELL SEPARATOR, FUEL CELL, AND MANUFACTURING METHOD OF FUEL CELL SEPARATOR

(71) Applicant: TOYOTA JIDOSHA KABUSHIKI KAISHA, Toyoya-shi, Aichi-ken (JP)

(72) Inventors: Masafumi KOIZUMI, Nagoya-shi, Aichi-ken (JP); Takashi ISEKI, Nagakute-shi, Aichi-ken (JP); Kazuyuki NAKANISHI, Nagakute-shi, Aichi-ken (JP); Yasuhiro OZAWA, Nagakute-shi, Aichi-ken (JP)

(73) Assignee: TOYOTA JIDOSHA KABUSHIKI KAISHA, Toyota-shi, Aichi-ken (JP)

(21) Appl. No.: 15/023,550

(22) PCT Filed: Sep. 18, 2014
(86) PCT No.: PCT/IB2014/001863

§ 371 Date: Mar. 21, 2016

(30) Foreign Application Priority Data
Sep. 24, 2013 (JP) 2013-197127

(51) Int. Cl. H01M 8/0213; H01M 4/92; H01M 8/1039; H01M 8/1004; H01M 8/1007

(52) U.S. Cl. CPC H01M 8/0213; H01M 8/1004; H01M 8/1007; H01M 8/1039; H01M 4/926; H01M 2008/1095

(57) ABSTRACT

A fuel cell separator includes an electrically-conductive base substrate and a carbon film formed on the base substrate. The carbon film includes a first layer formed closest to the base substrate, and a second layer formed farthest from the base substrate. A diameter of carbon particles included in the first layer is 19 nm or less, and is smaller than a diameter of carbon particles included in a layer of the carbon film other than the first layer, and a diameter of the carbon particles included in the second layer is 40 nm or less.

### BACKGROUND OF THE INVENTION

1. Field of the Invention

The present invention relates to a fuel cell separator, a fuel cell, and a manufacturing method of a fuel cell separator.

2. Description of Related Art

Conventionally, there has been known a technique described in Japanese Patent Application Publication No. 2008-004540 (JP 2008-004540 A), for example, as a technique related to a fuel cell separator. In the technique described in JP 2008-004540 A, in order to improve a corrosion resistance and a conductivity of the separator, a carbon thin film made of minute carbon particles is formed on a base substrate of the separator.

If the carbon particles to be formed on a surface of the base substrate are made small, adherence with respect to the base substrate improves. However, a deposition rate is slow, which causes such a problem that production efficiency is low. In the meantime, if a diameter of the carbon particles is increased to improve the production efficiency, such a problem is caused that durability of output of the fuel cell decreases. In addition, for conventional fuel cell separators and fuel cells, downsizing, reduction in cost, resource saving, simplification of manufacture, improvement of usability, and the like are demanded.

### SUMMARY OF THE INVENTION

An aspect of the present invention relates to a fuel cell separator. This fuel cell separator includes an electrically-conductive base substrate, and a carbon film formed on the base substrate. The carbon film includes a first layer formed closest to the base material, and a second layer formed farthest from the base substrate. A diameter of carbon particles included in the first layer is 19 nm or less, and is smaller than a diameter of carbon particles included in a layer of the carbon film other than the first layer. A diameter of carbon particles included in the second layer is 40 nm or less. Since the diameter of the carbon particles included in the first layer is 19 nm or less, it is possible to improve adherence between the base substrate and the first layer of the carbon film. Further, since the diameter of the carbon particles included in the second layer is 40 nm or less, it is possible to improve a deposition rate and to improve productive efficiency of the fuel cell separator, in comparison with a case where the carbon film is formed such that a diameter of whole carbon particles thereof is 19 nm or less. Further, it is possible to restrain water including a substance (hereinafter referred to as the corrosive substance) generated by power generation of the fuel cell and corroding the base substrate, from passing through the second layer and penetrating into the base substrate. As a result, it is possible to restrain the base substrate from corroding due to the water including the corrosive substance, thereby making it possible to restrain a decrease in output of a fuel cell.

The fuel cell separator according to the above aspect may further includes an intermediate layer containing components of both of the base substrate and the carbon film, the intermediate layer being provided between the base substrate and the carbon film. According to such a configuration, it is possible to further improve adherence between the base substrate and the carbon film by the intermediate layer.

A second aspect of the present invention relates to a fuel cell. The fuel cell includes an anode, a cathode, an electrolyte membrane which is sandwiched between the anode and the cathode; the fuel cell separator of the first aspect. According to the second aspect, it is possible to improve the adherence between the base substrate and the first layer of the carbon film, and to restrain the decrease in output of the fuel cell.

A third aspect of the present invention relates to a manufacturing method of a fuel cell separator. The manufacturing method includes a step (a) of preparing an electrically-conductive base substrate, and a step (b) of forming a carbon film on the base substrate by plasma CVD. The step (b) may include a step (b1) of forming a first layer of the carbon film as a layer closest to the base substrate, and a step (b2) of forming a second layer of the carbon film as a layer farthest from the base substrate. A flow rate of raw material gas at a time of forming the first layer in the step (b1) may be in a range from ½ to 1/50 of a flow rate of raw material gas at a time of forming the second layer in the step (b2). With such a configuration, it is possible to improve the adherence between the base substrate and the first layer of the carbon film, and to improve the productive efficiency of the fuel cell separator.

The present invention is achievable in various aspects other than the above aspects. For example, the present invention is achievable in a manufacturing method of a fuel cell, in a vehicle including a fuel cell, and the like aspects.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an explanatory view to describe a schematic configuration of a fuel cell according to one embodiment of the present invention;

FIG. 2 is an enlarged explanatory view illustrating part of a section of a separator;

FIG. 3 is a process drawing of a manufacturing method of a separator according to one embodiment of the present invention;

FIG. 4 is an explanatory view illustrating, in a graph format, a relationship between a diameter of carbon particles included in a second layer of a carbon film and an increasing amount of a resistance value after a durability test;

FIG. 5 is an explanatory view illustrating, in a tabular format, an experimental result of each sample;

FIG. 6 is an explanatory view illustrating an SEM picture of a surface of a carbon film of Sample 3;

FIG. 7 is an explanatory view illustrating an SEM picture of a surface of a carbon film of Sample 9;

FIG. 8 is an explanatory view illustrating an SEM picture of a surface of a carbon film of Sample 12;

FIG. 9 is an explanatory view illustrating an SEM picture of a surface of a carbon film of Sample 8;

FIG. 10 is an explanatory view illustrating an SEM picture of a surface of a carbon film of Sample 11; and

FIG. 11 is an explanatory view illustrating an SEM picture of a surface of a carbon film of Sample 12.

### DETAILED DESCRIPTION OF EMBODIMENTS

A mode for carrying out the present invention will be described below based on an embodiment in the following order.

### A. Embodiment:

### B. Example:

### C. Modifications:

### A. Embodiment

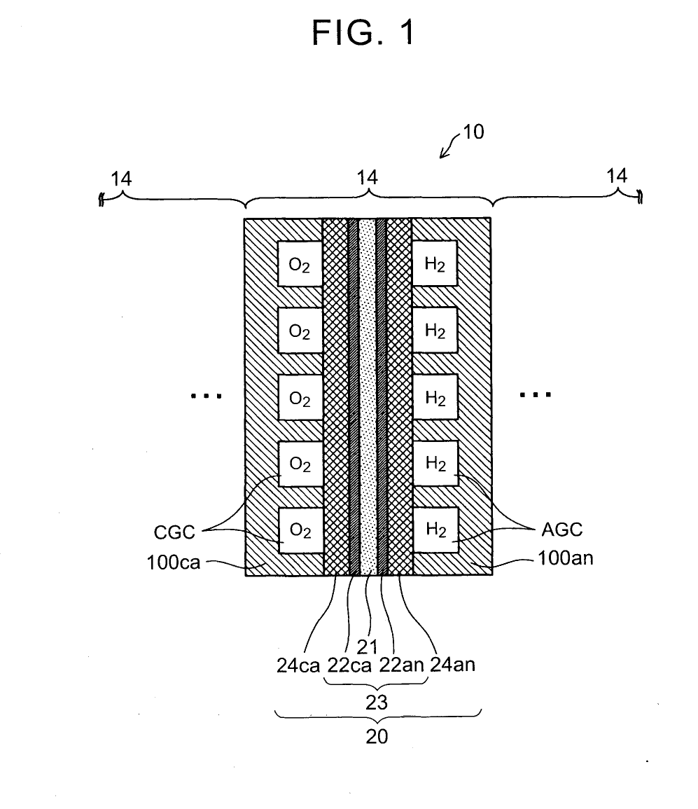

FIG. 1 is an explanatory view to describe a schematic configuration of a fuel cell 10 according to one embodiment of the present invention. The fuel cell 10 is a polymer electrolyte fuel cell, and has a stack structure in which a plurality of single cells 14 is laminated. The single cell 14 is a unit module that generates electricity in the fuel cell 10, and performs power generation by an electrochemical reaction between hydrogen gas and oxygen included in the air. Each of the single cells 14 includes a power generation body 20, a pair of separators 100 (an anode-side separator 100an and a cathode-side separator 100ca) sandwiching the power generation body 20 therebetween.

The power generation body 20 includes: a membrane electrode assembly (also referred to as MEA) 23 in which catalyst electrode layers 22 (an anode 22an and a cathode 22ca) are formed on both surfaces of an electrolyte membrane 21; and a pair of gas diffusion layers 24 (an anode-side diffusion layer 24an and a cathode-side diffusion layer 24ca) placed on both sides of the membrane electrode assembly 23.

The electrolyte membrane 21 is a polymer electrolyte membrane made of fluorine-based sulfonic acid polymer as a solid polymeric material, and has a good proton conductivity in a wet condition. In the present embodiment, a Nafion film (NRE212, Nafion is a registered trademark) is used as the electrolyte membrane 21. However, the electrolyte membrane 21 is not limited to Nafion (registered trademark), and other fluorine-based sulfonic acid membranes such as Aciplex (registered trademark) or Flemion (registered trademark) may be used, for example. Further, as the electrolyte membrane 21, a fluorine-based phosphoric acid membrane, a fluorine-based carboxylic acid membrane, a fluorine-based hydrocarbon graft membrane, a hydrocarbon-based graft membrane, an aromatic membrane or the like may be used. Furthermore, a composite polymer membrane containing a reinforcing material such as PTFE or polyamide so that a mechanical characteristic thereof is strengthened may be used.

The catalyst electrode layers 22 (the anode 22an and the cathode 22ca) are placed on both sides of the electrolyte membrane 21, so that when the fuel cell is used, one of them functions as an anode electrode, and the other one of them functions as a cathode electrode. The catalyst electrode layer 22 contains carbon particles (a catalyst carrying carrier) that carry a catalytic metal (platinum, in the present embodiment) that promotes an electrochemical reaction, and a proton-conductive polymer electrolyte (fluorine-based resin, in the present embodiment). A carbon material such as carbon black, carbon nanotube, or carbon nanofiber, or a carbon compound represented by silicon carbide may be used as the electrically-conductive catalyst carrying carrier, instead of the carbon particles. Further, platinum alloy, palladium, rhodium, gold, silver, osmium, iridium, or the like may be used as the catalytic metal, instead of platinum.

The gas diffusion layers 24 (the anode-side diffusion layer 24an and the cathode-side diffusion layer 24ca) are layers for diffusing reactant gas (anode gas and cathode gas) used for an electrode reaction along a surface direction of the electrolyte membrane 21. In the present embodiment, carbon paper is used as the gas diffusion layers 24. Note that, as the gas diffusion layers 24, a carbon porous material such as carbon cloth, or a metal porous material such as metal mesh or foam metal may be used, for example, instead of the carbon paper.

The separators 100 (the anode-side separator 100an and the cathode-side separator 100ca) are made of a member having a gas barrier property and an electronic conductivity. In the present embodiment, the separators 100 are made of titanium. However, the separators 100 may be made of other metallic components, for example, instead of titanium. The separators 100 will be described later in detail.

An uneven shape constituting passages where gas and liquid flow is formed on a surface of the separator 100. More specifically, the anode-side separator 100an includes anode gas passages AGC where gas and liquid can flow, between the anode-side separator 100an and the anode-side diffusion layer 24an. The cathode-side separator 100ca includes cathode gas passages CGC where gas and liquid can flow, between the cathode-side separator 100ca and the cathode-side diffusion layer 24ca.

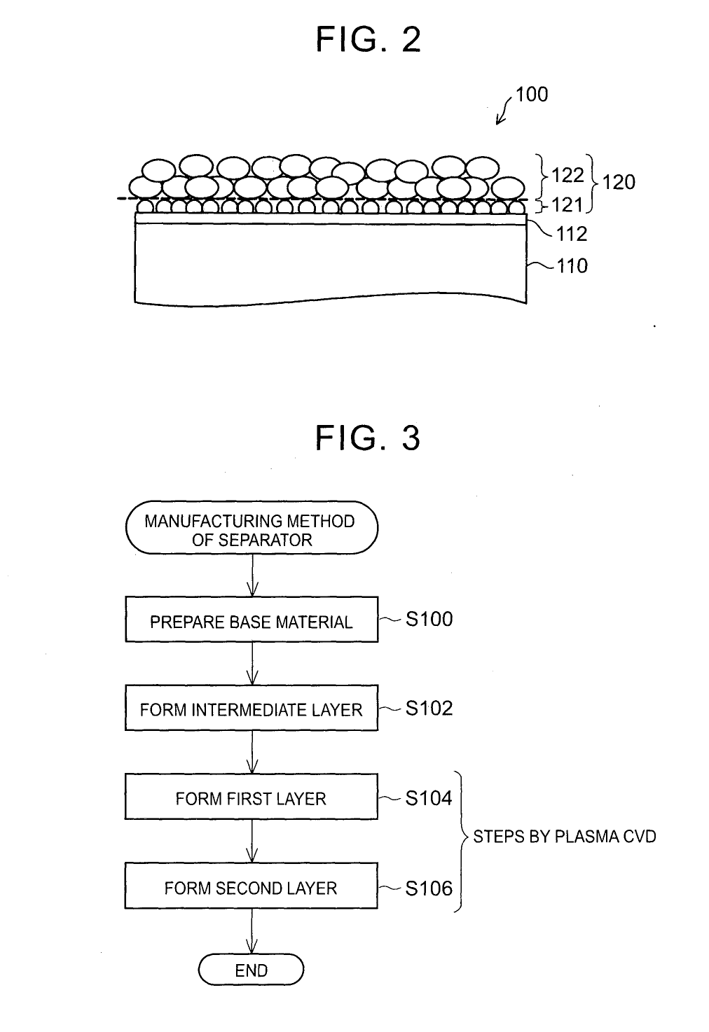

FIG. 2 is an enlarged explanatory view illustrating part of a section of the separator 100. The separator 100 includes a metal base substrate 110, an intermediate layer 112 formed on the metal base substrate 110, and a carbon film 120 formed on the intermediate layer 112. Note that the carbon film 120 is formed on that surface of the intermediate layer 112 which makes contact with the gas diffusion layer 24.

The metal base substrate 110 is made of an electrically-conductive metallic component, and in the present embodiment, the separator 100 is made of titanium. However, the metal base substrate 110 may be made of other metal such as stainless steel.

The carbon film 120 is formed on the intermediate layer 112, and improves a conductivity and a corrosion resistance of the separator 100. The carbon film 120 is formed by depositing carbon particles by plasma CVD. The carbon film 120 includes a first layer 121 formed on a surface of the metal base substrate 110, and a second layer 122 formed on a surface of the first layer 121. As will be described later, a diameter of carbon particles included in the first layer 121 is different from a diameter of carbon particles included in the second layer.

The intermediate layer 112 contains components of both of the metal base substrate 110 and the carbon film 120. In the present embodiment, the intermediate layer 112 is made of titanium carbide (TiC). The intermediate layer 112 has good adherence with respect to the metal base substrate 110, and also has good adherence with respect to the carbon film 120. In view of this, according to the present embodiment, it is possible to improve adherence between the metal base substrate 110 and the carbon film 120 by the intermediate layer 112. However, the carbon film 120 may be formed directly on the metal base substrate 110 without forming the intermediate layer 112.

In the present embodiment, the diameter of the carbon particles included in the first layer 121 is smaller than the diameter of the carbon particles included in the second layer 122, and the diameter of the carbon particles included in the first layer 121 is 19 nm or less. In view of this, according to the present embodiment, the carbon particles included in the first layer 121 is easy to get into minute uneven gaps on the surface of the metal base substrate 110 (the intermediate layer 112 when the intermediate layer 112 is formed). This makes it possible to improve adherence between the first layer 121 of the carbon film 120 and the metal base substrate 110 (the intermediate layer 112 when the intermediate layer 112 is formed).

Further, in the present embodiment, the diameter of the carbon particles included in the second layer 122 is 40 nm or less. In view of this, according to the present embodiment, it is possible to improve a deposition rate and to improve productive efficiency of the separator 100, in comparison with a case where the carbon film 120 is formed such that a diameter of whole carbon particles thereof is 19 nm or less. Further, according to the present embodiment, since gaps between the carbon particles included in the second layer 122 are small, it is possible to restrain water including a corrosive substance (a substance that corrodes the metal base substrate 110 and the intermediate layer 112) generated by power generation of the fuel cell, from passing through the second layer 122 and penetrating into the metal base substrate 110 and the intermediate layer 112. As a result, it is possible to restrain the metal base substrate 110 and the intermediate layer 112 from corroding due to the water including the corrosive substance, thereby making it possible to restrain a decrease in output of the fuel cell.

Note that, in the present specification, the “diameter of particles” indicates an average particle diameter, and the average particle diameter is calculated by performing image analysis on an image obtained by FE-SEM (Field Emission-Scanning Electron Microscope).

FIG. 3 is a process drawing of a manufacturing method of the separator 100 according to one embodiment of the present invention. In step S100, a metal base substrate 110 is prepared. In the present embodiment, a titanium metal base substrate 110 is prepared.

In step S102, an intermediate layer 112 is formed on the metal base substrate 110. In the present embodiment, a titanium carbide layer is formed as the intermediate layer 112 on the titanium metal base substrate 110.

In step S104, a first layer 121 of a carbon film 120 is formed on the intermediate layer 112. In the present embodiment, the first layer 121 of the carbon film 120 is formed by plasma CVD using hydrocarbon-based gas. At the time of the plasma CVD, a flow rate of the gas is adjusted so that a diameter of carbon particles included in the first layer 121 of the carbon film 120 becomes 19 nm or less.

In step S106, a second layer 122 of the carbon film 120 is formed on the first layer 121 of the carbon film 120. In the present embodiment, the second layer 122 of the carbon film 120 is formed by plasma CVD using hydrocarbon-based gas. At the time of the plasma CVD, a flow rate of the gas is adjusted so that a diameter of carbon particles included in the second layer 122 of the carbon film 120 becomes 40 nm or less.

In the present embodiment, the flow rate of raw material gas at the time of forming the first layer 121 in step S104 is set to be in a range from ½ to 1/50 of the flow rate of raw material gas at the time of forming the second layer 122 in step S106. As in the present embodiment, when the flow rate of the raw material gas at the time of forming the first layer 121 is set to be ½ or less of the flow rate of the raw material gas at the time of forming the second layer 122, it is possible to improve the adherence of the first layer 121 with respect to the metal base substrate 110 (and the intermediate layer 112). When the flow rate of the raw material gas at the time of forming the first layer 121 is set to be 1/50 or more of the flow rate of the raw material gas at the time of forming the second layer 122, it is possible to shorten time required to form the first layer 121. Thus, when the flow rates of the raw material gases are set as described above, it is possible to improve productive efficiency of the separator 100.

### B. Example

In this example, a plurality of samples of the fuel cell separator was formed, and a resistance value of each sample was measured. Then, fuel cells were formed by using the samples of the fuel cell separator, and a durability test in which power generation is performed for a predetermined time was performed thereon. After the durability test, a resistance value of each of the samples of the fuel cell separator was measured, so as to measure an increasing amount of the resistance value after the durability test was measured.

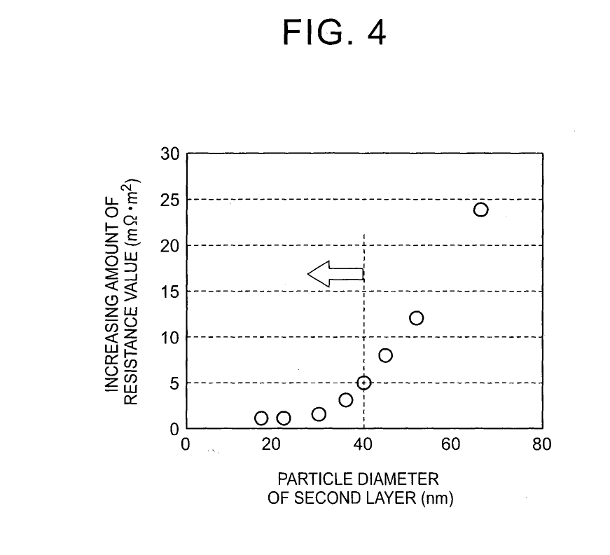

FIG. 4 is an explanatory view illustrating, in a graph format, a relationship between a diameter of carbon particles included in the second layer 122 of the carbon film 120 and the increasing amount of the resistance value after the durability test. Note that the diameter of the carbon particles of the first layer 121 in each of the samples used in this example is 19 nm or less.

According to FIG. 4, it can be understood that, as the diameter of the carbon particles included in the second layer 122 becomes smaller, the increasing amount of the resistance value after the durability test is decreased. Further, it can be understood that if the diameter of the carbon particles included in the second layer 122 is 40 nm or less, the resistance value hardly increases, and the increasing amount of the resistance value after the durability test is 5 [mΩ·m²] or less. The reason is as follows: As described above, if the diameter of the carbon particles included in the second layer 122 is 40 nm or less, the gaps between the particles are small, thereby making it possible to restrain water including a corrosive substance generated by power generation of the fuel cell, from passing through the second layer 122 and penetrating into the metal base substrate 110 and the intermediate layer 112. As a result, it is possible to restrain the metal base substrate 110 and the intermediate layer 112 from corroding due to the water including the corrosive substance. In view of this, it is preferable that the diameter of the carbon particles included in the second layer 122 be 40 nm or less.

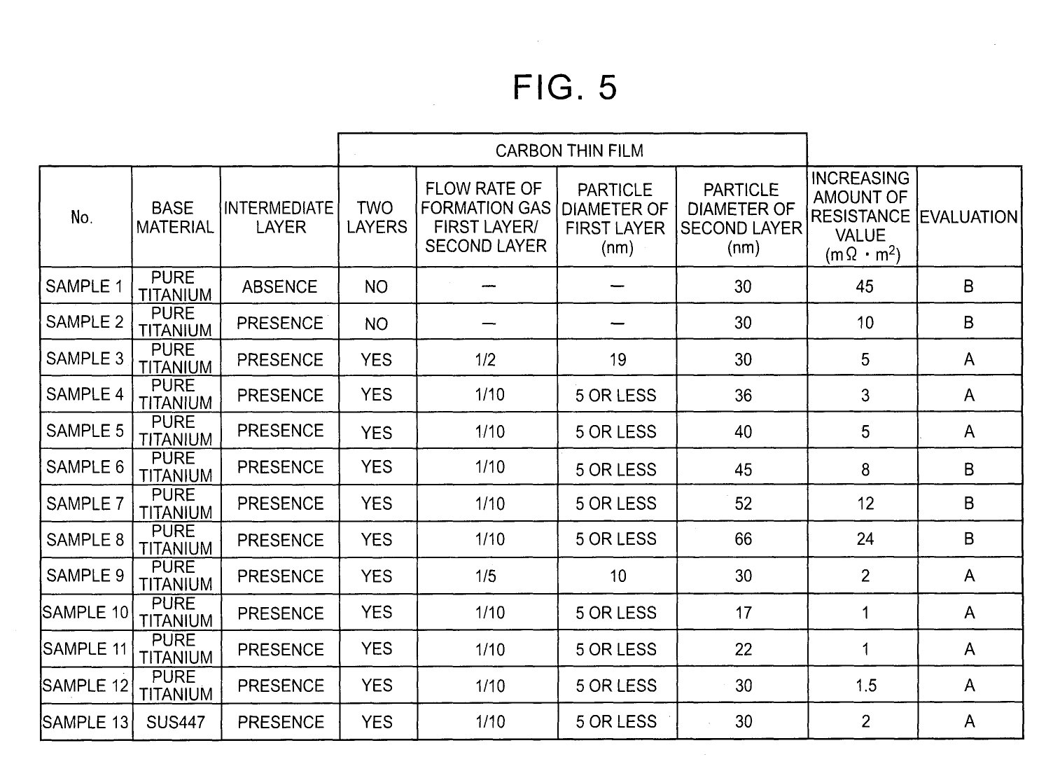

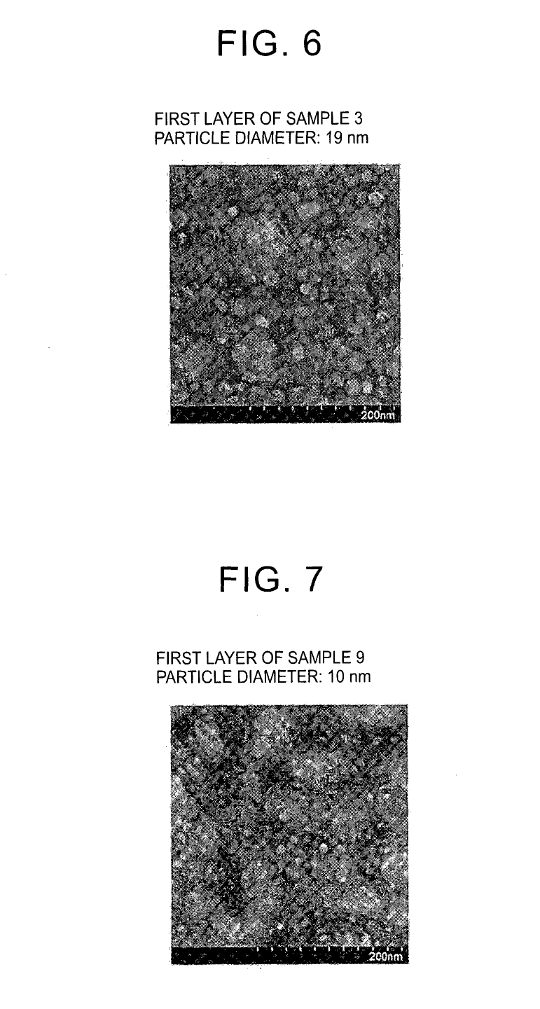

FIG. 5 is an explanatory view illustrating, in a tabular, format, an experimental result of each of the samples. FIGS. 6 to 11 are explanatory views each illustrating an SEM picture of a surface of the carbon film 120 of each of the samples. The correspondence between the figures and the samples is as follows.

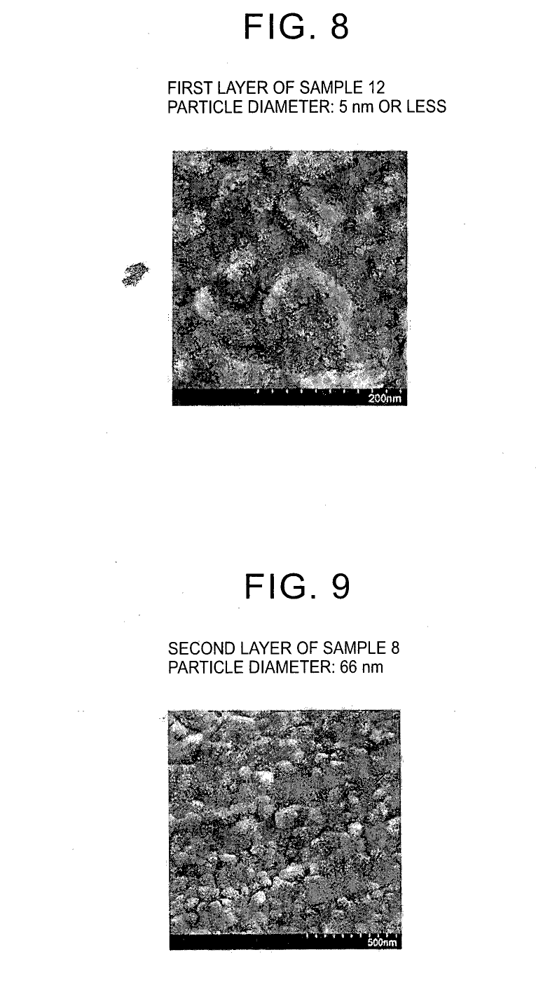

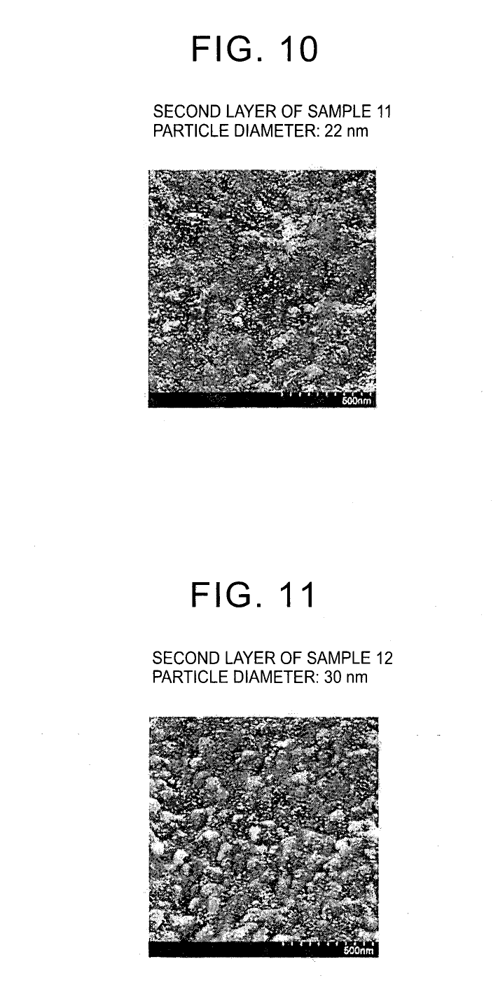

FIG. 6: Surface of the first layer 121 of Sample 3
FIG. 7: Surface of the first layer 121 of Sample 9
FIG. 8: Surface of the first layer 121 of Sample 12
FIG. 9: Surface of the second layer 122 of Sample 8
FIG. 10: Surface of the second layer 122 of Sample 11
FIG. 11: Surface of the second layer 122 of Sample 12

In evaluation of FIG. 5, in a case where the increasing amount of the resistance value of a sample after the durability test is more than 5 [mΩ·m² (mΩ is milliohm)], it is determined that its durability is low and the sample is evaluated as “B,” and in a case where the increasing amount of the resistance value of a sample after the durability test is not more than 5 [mΩ·m²], it is determined that its durability is high and the sample is evaluated as “A.”

According to Sample 1 and Sample 2, it can be understood that, in a case where the carbon film 120 is not formed in two layers, that is, in a case where the first layer 121 of a small particle diameter is not formed, the increasing amount of the resistance value is large regardless of whether the intermediate layer 112 is provided or not, and the durability is low.

According to Sample 3 to Sample 5, it can be understood that when the diameter of the carbon particles of the first layer 121 is 19 nm or less and the diameter of the carbon particles of the second layer 122 is 40 nm or less, the durability is high.

According to Sample 6 to Sample 8, it can be understood that, even in a case where the diameter of the carbon particles of the first layer 121 is 5 nm or less, when the diameter of the carbon particles of the second layer 122 is more than 40 nm, the durability is low.

According to Sample 9 to Sample 13, it can be understood that, when the diameter of the carbon particles of the first layer 121 is 10 nm or less and the diameter of the carbon particles of the second layer 122 is 30 nm or less, the increasing amount of the resistance value is 2 [mΩ·m²] or less, and thus, the durability is very high.

Note that, according to Sample 4 to Sample 13, it can be understood that when the flow rate of the raw material gas at the time of forming the first layer 121 is in a range from ½ to 1/10 of the flow rate of the raw material gas at the time of forming the second layer 122, the diameter of the carbon particles of the first layer 121 becomes 19 nm or less.

Accordingly, the diameter of the carbon particles of the first layer 121 is preferably 19 nm or less, further preferably 10 nm or less, and particularly preferably 5 nm or less. Further, the diameter of the carbon particles of the second layer 122 is preferably 40 nm or less, and further preferably 30 nm or less.

The flow rate of the raw material gas at the time of forming a first layer in which a diameter of carbon particles is 19 nm or less is from 1 sccm to 2000 sccm per 1 m² of a processed member e.g., the metal base substrate 110 of the above embodiment. The flow rate of the raw material gas at the time of forming a second layer in which a diameter of carbon particles is 40 nm or less is equal to or smaller than 50000 sccm per 1 m² of a processed member e.g., the first layer 121 of the above embodiment and is larger than the flow rate of the raw material gas at the time of forming the first layer. For example, in the sample 11, the flow rate of the raw material gas at the time of forming the first layer 121 is 500 sccm per 1 m² of the metal base substrate 110. The flow rate of the raw material gas at the time of forming the second layer 122 is 5000 sccm per 1 m² of the first layer 121.

### C. Modifications

Note that the present invention is not limited to the above embodiment and the above example, and is performable in various forms within a range that does not deviate from the gist of the present invention. For example, the following modifications can be employed.

Modification 1: In the above embodiment, the carbon film 120 may be constituted by three or more layers. In this case, it is preferable that a diameter of carbon particles included in a layer formed closest to the metal base substrate 110 among the three or more layers constituting the carbon film 120 be smaller than diameters of carbon particles included in the other layers of the carbon film 120.

Further, a diameter of carbon particles included in a layer formed farthest from the metal base substrate 110 among the three or more layers constituting the carbon film 120 is preferably 40 nm or less, and the diameter of the carbon particles included in the layer formed closest to the metal base substrate 110 is preferably 19 nm or less.

Modification 2: In the above embodiment, in a case where the metal base substrate 110 is made of titanium, the intermediate layer 112 may be made of TiC₂, for example. Further, in a case where the metal base substrate 110 is made of stainless steel (SUS), the intermediate layer 112 may be made of Fe₃C, Cr₂₃C₆, or the like, for example.

The present invention is not limited to the above embodiment, example, and modifications, and is achievable in various configurations within a range that does not deviate from the gist of the present invention. For example, those technical features of the embodiment, the example, and the modifications which correspond to the technical features of each aspect described in SUMMARY OF THE INVENTION can be replaced or combined appropriately, in order to resolve some or all of the problems described above or in order to achieve some or all of the above effects. Further, the technical features can be deleted appropriately if the technical features have not been described as essential in the present specification.

1. A fuel cell separator, comprising:
an electrically-conductive base substrate; and
a carbon film formed on the base substrate, wherein:
the carbon film includes a first layer formed closest to the base substrate, and a second layer formed farthest from the base substrate;
an average diameter of carbon particles included in the first layer is 19 nm or less, and is smaller than an average diameter of carbon particles included in a layer of the carbon film other than the first layer; and
an average diameter of carbon particles included in the second layer is 17 nm or more and 40 nm or less.

2. The fuel cell separator according to claim 1, further comprising:
an intermediate layer containing components of both of the base substrate and the carbon film, the intermediate layer being provided between the base substrate and the carbon film.

3. A fuel cell comprising:
an anode;
a cathode;
an electrolyte membrane which is sandwiched between the anode and the cathode; and
the fuel cell separator according to claim 1.

4. A manufacturing method of the fuel cell separator according to claim 1, comprising:
a step (a) of preparing the electrically-conductive base substrate; and
a step (b) of forming the carbon film on the base substrate by plasma CVD,
wherein:
the step (b) includes
a step (b1) of forming the first layer of the carbon film as the layer closest to the base substrate, and
a step (b2) of forming the second layer of the carbon film as the layer farthest from the base substrate; and
a flow rate of raw material gas at a time of forming the first layer in the step (b1) is in a range from ½ to 1/50 of a flow rate of raw material gas at a time of forming the second layer in the step (b2).

5. The manufacturing method according to claim 4, wherein:
the flow rate of the raw material gas at the time of forming the first layer in the step (b1) is a flow rate at which carbon particles included in the first layer are formed to have the average diameter of 19 nm or less; and
the flow rate of the raw material gas at the time of forming the second layer in the step (b2) is a flow rate at which carbon particles included in the second layer are formed to have the average diameter of 17 nm or more and 40 nm or less.
